(19) United States
(12) Patent Application Publication
(10) Pub. No.: US 2010/0028705 A1
(43) Pub. Date: Feb. 4, 2010

(54) DISSIMILAR METAL TRANSITION FOR SUPERHEATER OR REHEATER TUBES

(75) Inventor: William A. Keegan, New Hartford, CT (US)

Correspondence Address: ALSTOM POWER INC.;INTELLECTUAL PROPERTY LAW DEPT., P.O. BOX 500, WINDSOR, CT, 06095, US

(73) Assignee: ALSTOM Technology Ltd, Baden (CH)

(21) Appl. No.: 12/578,976

(22) Filed: Oct. 14, 2009

Related U.S. Application Data
(63) Continuation-in-part of application No. 11/470,292, filed on Sep. 6, 2006.

(51) Int. Cl. B32B 15/16; B23K 20/02; B23K 31/00

(52) U.S. Cl. 428/554; 228/175; 228/248.1

(57) ABSTRACT

A tube joint (16) for joining dissimilar metal sections (12, 14) of a superheater or reheater tube (10) is formed using a hot isostatic press process. A first end of the tube joint (16) is formed from a first metal which has substantially the same chemical composition as that of one section (12) of the superheater or reheater tube (10), and a second end of the tube joint is formed from a second metal which has substantially the same chemical composition as a metal used to form the other section (14) of the superheater or reheater tube (10). Because the ends of the tube joint (16) are made of substantially the same metal as the respective tube sections (12, 14) to which they attach, the welds (18) may be performed using a standard fusion welding process, such as arc welding, and the need for dissimilar metal welding is eliminated.

### CROSS REFERENCE TO RELATED APPLICATIONS

This application is a continuation-in-part application of co-pending U.S. utility application entitled, “DISSIMILAR METAL TRANSITION FOR SUPERHEATER OR REHEATER TUBES,” having Ser. No. 11/470,292, filed Sep. 6, 2006, Attorney Docket Number WO4/002-0, the disclosure of which is entirely incorporated herein by reference.

### TECHNICAL FIELD

The present disclosure relates to superheater or reheater tubes used in utility and industrial steam generators; more particularly, the present disclosure relates to a means for joining dissimilar metal portions of such tubes.

### BACKGROUND

Certain types of utility and industrial steam generators (boilers) include one or more banks of tubing, known as superheaters or reheaters, in which steam temperature is raised above the saturated temperature level. In designing a superheater or reheater, selection of tube materials is an important consideration. The material used in the tubes must be selected to withstand the stresses associated with the steam temperatures and pressures to which the tubes will be subjected. Codes such as, for example, the American Society of Mechanical Engineers (ASME) Boiler and Pressure Vessel Code dictate the allowable stresses for various superheater and reheater tube materials. At the same time, the selection of tube material must take into account the manufacturing cost of the tube. In general, the greater the allowable stress of a material, the higher its cost. Thus, proper material selection for superheater and reheater tubes requires consideration of both allowable stress and cost.

One way of reducing tube cost while meeting allowable stress requirements is to manufacture each superheater and reheater tube from different materials, with each material being selected based on the required allowable stress for that portion of the tube. That is, one portion of the tube is manufactured from a lower cost, lower allowable stress material, while another portion of the same tube is manufactured from a higher cost, higher allowable stress material. For example, a portion of a tube located in a relatively high temperature region of the boiler may be manufactured in accordance with ASTM International (ASTM) standard A213 Grades TP304, TP309, TP310, TP347 which are relatively high cost, austenitic stainless steel tubes, while a portion of the same tube located in a relatively low temperature region of the boiler may be manufactured in accordance with ASTM A213 Grade T22 or Grade T11, which are relatively low cost, ferritic steel tubes. (There may be several variants of each of these grades that may also be used.) In this manner, tube cost is reduced below that which would be required to manufacture the tube entirely from the higher cost material.

The manufacture of such composite-material superheater or reheater tubes typically requires that the two, dissimilar metal tube segments be joined together by a single weld, known as a dissimilar metal weld (DMW). However, performing a DMW is a difficult process that must be done by specially trained welders. As a result, the DMWs are time consuming and costly. Furthermore, DMWs are known failure points in superheater and reheater tubes, which result in decreased life of the tubes. While not wanting to be bound by theory, it is believed that the failure of DMWs is caused at least in part by differences in thermal expansion of the dissimilar metals. This mismatch is believed to result in high shear strains at the interface between the two different metals, and, with cycling, these strains can cause intergranular cracking within the weaker material.

Failure of DMWs between the dissimilar metals used in composite-material superheater and reheater tubes constitutes a cause of forced outages in boilers. Utilities and research institutes spend millions of dollars each year replacing and analyzing DMWs to identify root causes of failures and to develop remedies. Typical remedies include modified weld preparations and more carefully controlled welding processes, both of which increase the time and cost to perform the DMW. Thus, there remains a need for a means of joining dissimilar metal portions of superheater or reheater tubes that eliminates the need for DMWs.

### SUMMARY

The above-described and other drawbacks and deficiencies of the prior art are overcome or alleviated by a method of forming a tube joint for joining dissimilar metal sections of a superheater or reheater tube, the method comprising: providing a first metal having substantially the same chemical composition as a metal used to form one of the sections of the superheater or reheater tube; providing a second metal having substantially the same chemical composition as a metal used to form the other of the sections of the superheater or reheater tube, the chemical composition of the second metal being different than that of the first metal; and applying a hot isostatic press process to the first and second metals to provide a tube joint having a first end formed from the first metal and a second end formed from the second metal.

In another aspect, there is provided a method of joining dissimilar metal sections of a superheater or reheater tube, the method comprising: providing a first metal having substantially the same chemical composition as a metal used to form a first section of the superheater or reheater tube; providing a second metal having substantially the same chemical composition as a metal used to form a second section of the superheater or reheater tube, the chemical composition of the second metal being different than that of the first metal; applying a hot isostatic press process to the first and second metals to provide a tube joint having a first end formed from the first metal and a second end formed from the second metal; welding the first end of the tube joint to the first section of the superheater or reheater tube; and welding the second end of the tube joint to the second section of the superheater or reheater tube to join the first and second sections of the superheater or reheater tube.

In yet another aspect, there is provided a method of forming a tube joint for joining dissimilar metal sections of a superheater or reheater tube, the method comprising: providing a first end portion formed from a first metal having substantially the same chemical composition as a metal used to form one of the sections of the superheater or reheater tube; providing a second end portion formed from a second metal having substantially the same chemical composition as a metal used to form the other of the sections of the superheater or reheater tube, the chemical composition of the second metal being different than that of the first metal; providing powdered metals between the first and second end portions; and applying a hot isostatic press process to bond the powdered metals with the first and second end portions and provide a tube joint having a first end formed from the first metal and a second end formed from the second metal. The powdered metals are selected from one of: a mixture of the first and second metals, a third metal having a different chemical composition than the first and second metals, and a mixture of the first, second, and third metals. In one embodiment, the first metal is a ferritic steel, the second metal is an austenitic stainless steel, and the third metal is a nickel-based alloy.

### BRIEF DESCRIPTION OF THE DRAWINGS

Referring now to the appended drawings wherein like items are numbered alike in the various Figures:

FIG. 1 is an elevation view of a portion of a superheater or reheater tube including dissimilar metal tube sections joined by a tube joint of the present invention;

FIG. 2 is a perspective view of the tube joint of FIG. 1;

FIG. 3 is a perspective, partial cut-away view of the tube joint disposed in a container during fabrication using a hot isostatic press process; and

FIGS. 4A-4D are schematic cross-sectional views of the tube joint, each depicting a different material composition.

### DETAILED DESCRIPTION

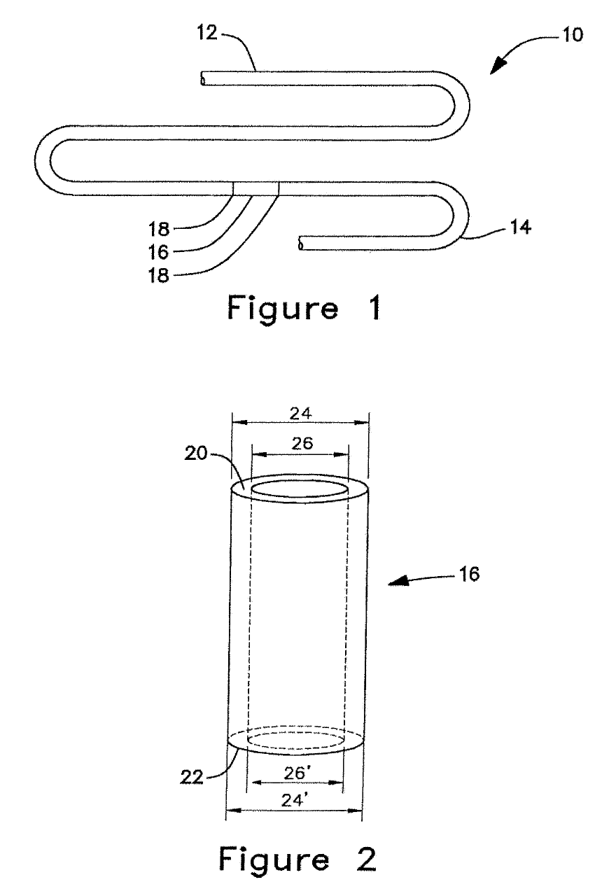

FIG. 1 depicts a tube 10 as may be found in a superheater or reheater of a utility or industrial boiler. While only one tube 10 is shown, it will be appreciated that a superheater or reheater will include a plurality of tubes 10. Also, it will be appreciated that the arrangement of the tube 10 is shown for example only, and other arrangements may be used.

As can be seen in FIG. 1, the tube 10 includes first tube section 12 coupled to a second tube section 14 by a tube joint 16. The first and second tube sections 12, 14 are coupled to the tube joint 16 by welds 18. The first and second tube sections 12 and 14 are formed from dissimilar (different) metals, with each metal being selected based on the required allowable stress for that section of the tube 10. As used herein, two metals are “dissimilar” or “different” if they have different chemical compositions, not accounting for impurities. For example, if the first section 12 of the tube 10 is located in a relatively high temperature region of a boiler, it may be manufactured in accordance with ASTM A213 Grades TP304, TP304L, TP304H, TP304N, TP304LN, TP309S, TP309H, TP309Cb, TP309HCb, TP310S, TP-310H TP310Cb, TP310HCb, TP310HCbN TP310MoLN, TP347, TP347H, TP347HFG and TP347LN. These alloys are relatively high cost, austenitic (chromium-nickel) stainless steel.

However, if the second section 14 of the tube 10 is located in a relatively low temperature region of the boiler it may be manufactured from a different metal such as, for example the second section 14 may be manufactured in accordance with ASTM A213 Grade T22 or Grade T11, which are relatively low cost, ferritic steel tubes. The table below provides the chemical compositions for each of these ASTM grades, which are also described in ASTM A213 (ASME SA213) “Specifications For Seamless Ferritic And Austenitic Alloy Steel Boiler Superheater And Heat Exchanger Tubes”, available from ASTM International of West Conshohocken, Pa.

| ASTM | Chemical Composition (weight %) | | | | | | |
|---|---|---|---|---|---|---|---|
| Grade | C | Si | Mn | Ni | Cr | Mo | Nb |
| T11 | 005-0.15. | 0.50-1.00 | 0.30-0.60 | — | 1.00-1.50 | 0.44-0.65 | — |
| T22 | 0.05-0.15 | 0.50 | 0.30-0.60 | — | 1.90-2.60 | 0.87-1.13 | — |
| TP304 | 0.08 | 1.00 | 2.00 | 8.0-11.0 | 18.0-20.0 | — | — |
| TP304L | 0.035 | 1.00 | 2.00 | 8.0-12.0 | 18.0-20.0 | — | — |
| TP304H | 0.04-0.10 | 1.00 | 2.00 | 8.0-11.0 | 18.0-20.0 | — | — |
| TP304N | 0.08 | 1.00 | 2.00 | 8.0-11.0 | 18.0-20.0 | — | — |
| TP304LN | 0.035 | 1.00 | 2.00 | 8.0-11.0 | 18.0-20.0 | — | — |
| TP309S | 0.08 | 1.00 | 2.00 | 12.00-15.00 | 22.00-24.00 | — | — |
| TP309H | 0.04-0.10 | 1.00 | 2.00 | 12.00-15.00 | 22.00-24.00 | — | — |
| TP309Cb | 0.08 | 1.00 | 2.00 | 12.00-16.00 | 22.00-24.00 | — | — |
| TP309HCb | 0.04-0.10 | 1.00 | 2.00 | 12.00-16.00 | 22.00-24.00 | — | — |
| TP310S | 0.08 | 1.00 | 2.00 | 19.00-22.00 | 24.00-26.00 | — | — |
| TP310H | 0.04-0.10 | 1.00 | 2.00 | 19.00-22.00 | 24.00-26.00 | — | — |
| TP310Cb | 0.08 | 1.00 | 2.00 | 19.00-22.00 | 24.00-26.00 | — | — |
| TP310HCb | 0.04-0.10 | 1.00 | 2.00 | 19.00-22.00 | 24.00-26.00 | — | — |
| TP310HCbN | 0.04-0.10 | 1.00 | 2.00 | 19.00-22.00 | 24.00-26.00 | — | — |
| TP310MoLN | 0.025 | 0.40 | 2.00 | 21.00-23.00 | 24.00-26.00 | 2.00-3.00 | — |
| TP347 | ≦0.08 | 1.00 | 2.00 | 9.00-13.00 | 17.0-20.0 | — | 10xC- |
| | | | | | | | 1.10 |
| TP347H | 0.04-0.10 | 1.00 | 2.00 | 9.00-13.00 | 17.0-19.0 | — | 8xC- |
| | | | | | | | 1.10 |
| TP347HFG | 0.06-0.10 | 1.00 | 2.00 | 9.00-13.00 | 17.0-19.0 | — | 8xC- |
| | | | | | | | 1.10 |
| TP347LN | 0.005-0.020 | 1.00 | 2.00 | 9.00-12.00 | 17.0-19.0 | — | 0.02-0.50 |

Referring to FIG. 2, a perspective view of the tube joint 16 is shown. As used herein, a “tube joint” is any relatively small section of tube which is welded between two relatively large sections of tube to join the relatively large sections of tube. In the embodiment shown, the tube joint 16 is a generally cylindrical shell having a first end 20, a second end 22, an outside diameter 24, and an inside diameter 26.

Referring to FIGS. 1 and 2, the tube joint 16 is formed from at least two different metals such that the first end 20 of the tube joint 16 is substantially the same metal as the first tube section 12 and the second end 22 of the tube joint 16 is substantially the same metal as the second tube section 14. By “substantially the same metal” it is meant that the two metals same chemical composition, not accounting for impurities. For example, two metals having a chemical composition that would fall within the same grade of an ASTM standard for superheater or reheater tubing are considered to be substantially the same. Because the ends 20 and 22 of the tube joint 16 are made of substantially the same metal as the respective tube sections 12, 14 to which they attach, the welds 18 may be performed using a standard fusion welding process, such as arc welding. The use of dissimilar metal welding (DMW), and the drawbacks and deficiencies associated with DMW, are eliminated.

To facilitate welding and to ensure a smooth fluid (steam) flow through the tube joint 16, the inside and outside diameters 24, 26 at the first end 20 may be substantially equal to the inside and outside diameters of the first tube section 12 (FIG. 1); similarly, the inside and outside diameters 24′, 26′ at the second end 22 may be substantially equal to the inside and outside diameters of the respective second tube section 14 (FIG. 1). Thus, where the tube sections 12 and 14 are of the same size, the tube joint 16 may be substantially cylindrical. Where the first and second tube sections 12 and 14 have different wall thicknesses, as may be required to account for the different allowable stresses of the materials used in the tube sections 12 and 14, the inside diameters 26 and 26′ and/or the outside diameters 24 and 24′ may be different at each end 20 and 22. While FIG. 2 shows one configuration of the tube joint 16, it is contemplated that other convenient shapes may be used, provided that the tube joint 16 is configured to mechanically couple, and provide fluid communication between, the first and second tube sections 12 and 14.

The tube joint 16 is formed using a hot isostatic press (HIP) process. As used herein, a “hot isostatic press process” is a process wherein powdered metal or a metal preform is subjected to heat and pressure simultaneously to bond the metal and reduce or eliminate internal voids. The HIP process can be used directly to consolidate powdered metals or supplementary to further densify a cold pressed, sintered, or cast preform.

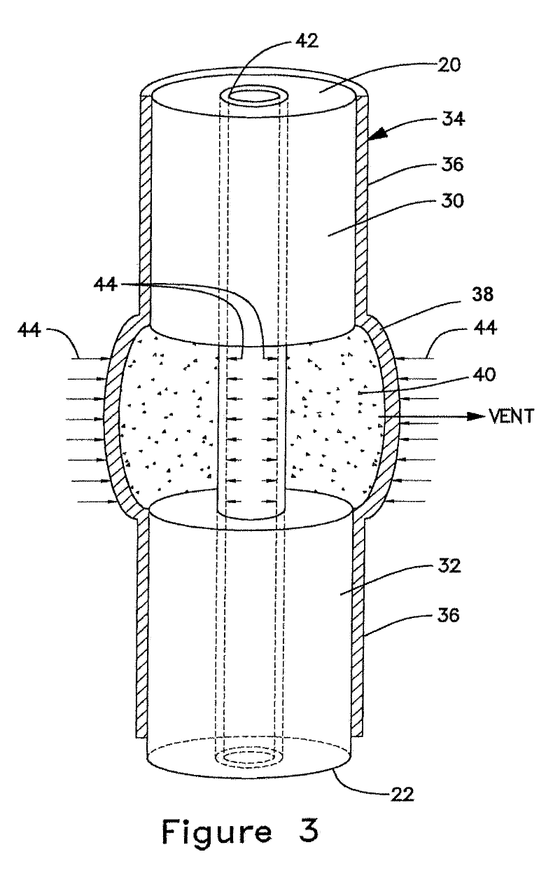

Referring to FIG. 3, one example of using a HIP process to form the joint 16 is shown. A first cylindrical end portion 30, which is substantially the same metal as the first tube section 12 (FIG. 1), and a second cylindrical end portion 32, which is substantially the same metal as the second tube section 14 (FIG. 1), are placed in a container 34. The inside and outside diameters of the first and second cylindrical end portions 30 and 32 may be selected based on the inside and outside diameters of the tube sections 12 and 14 (FIG. 1), as previously described with reference to FIG. 2. The container 34 includes end portions 36 that are fit to the outside diameter of the cylindrical end portions 30, 32 to hold the cylindrical end portions 30, 32 in-place. Located between the end portions 36 of the container 34 is a larger diameter portion 38 of the container 34, which receives powdered metal 40 for the HIP process. Disposed along the longitudinal axis of the container 34 and within the inside diameter of the first and second cylindrical end portions 30 and 32 is a metal cylinder 42.

During the HIP process, the container 34 is subjected to elevated temperature and a high vacuum to remove air and moisture from the powder 40. The container 34 is then sealed and inert gas is applied (as indicated at 44) at high, isostatic pressures and elevated temperatures, which results in the removal of internal voids and creates a strong metallurgical bond between the once powdered metal 40 (now solid), and the materials of the first and second cylindrical end portions 30, 32. The pressures and temperatures used in the HIP process are dependent on the type and quantity of metal used and the duration during which the pressure and temperature are applied. For example, pressures may range from about 40 to about 300 MPa (6,000-44,000 psi) and temperatures may range from about 500 to about 3,000° C. (900-5400° F.). After the HIP process, the container 34 and cylinder 42 are removed to reveal a preform of the tube joint 16, which may be machined into the desired shape.

In conventional welding, a heat-affected zone spans into both parts being welded together. Carbon permeates into both zones during the welding process. The heat form the welding process causes the carbon to create carbide compounds. These carbide compounds tend to fuse together over time creating brittle regions in the weld and adjacent heat-affected zones. These regions are then prone to cracking.

The HIP process fuses the metals into a solid unit in a vacuum environment. It does not create significant amount of carbides and therefore does not develop the brittle regions as is common in prior art welding. This results in a more consistent, higher-quality weld.

While FIG. 3 depicts the use of the HIP process to join the two cylindrical end portions 30, 32, it is also contemplated that the entire joint 16 may be fabricated using the HIP process (i.e. without any cylindrical end portions 30, 32).

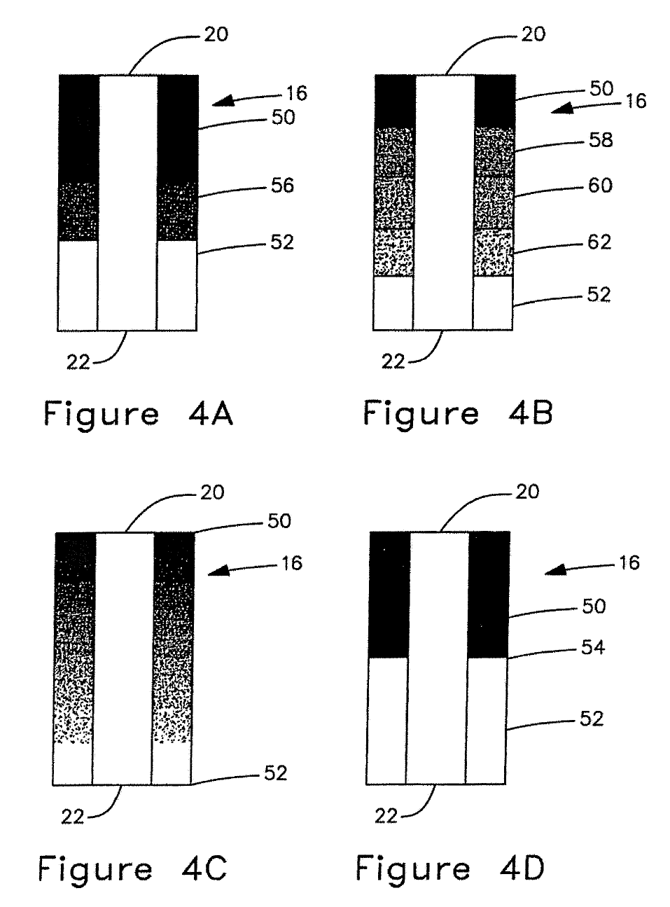

FIGS. 4A-4D are schematic cross-sectional views of the tube joint 16, each depicting a different material arrangement. In each of FIGS. 4A-4D end 20 of the tube joint 16 is formed from a first metal 50, and opposite end 22 is formed from a second metal 52. Referring to FIG. 1 and FIGS. 4A-D, the first metal 50 is substantially the same as that used in the first tube section 12 of the tube 10, and the second metal 52 is substantially the same as that used in the second tube section 14 of tube 10. For example, the first metal 50 may be an austenitic stainless steel (e.g., having the chemical composition of ASTM A213 grade TP304 or TP347) and the second metal may be a ferritic steel (e.g., having the chemical composition of ASTM A213 grade T11 or T22). As previously noted, because the ends 20 and 22 of the tube joint 16 are made of substantially the same metal as the respective tube sections 12, 14 to which they attach, the use of dissimilar metal welding (DMW), and the drawbacks and deficiencies associated with DMW, are eliminated.

In FIG. 4A, the first and second metals 50, 52 are each bonded to a transition section 56 of the tube joint 16. The transitions section 56 may be formed from: a combination of the first and second metals 50, 52; a combination of the first and second metals 50, 52 with one or more different metals; or one or more different metals without the first and second metals 50, 52.

For example, the best results were found using a first and second metals 50, 52 of an austenitic stainless steel and a ferritic steel, respectively, and the section 56 formed from a powdered nickel-based alloy such as, for example, Inconel® 625, which is commercially available from Special Metals Corporation of New Hartford, N.Y. A “nickel-based” alloy is an alloy whose main constituent is nickel. In another example, the section 56 may be formed from a 50%/50% (by weight) or other ratio mixture of the first and second metals 50, 52.

In yet another example, the first and second metals 50, 52 may be an austenitic stainless steel and a ferritic steel, respectively, and the third metal 56 may be a mixture of an austenitic stainless steel, a ferritic steel, and a nickel alloy.

Since the transition section 56 must be able to adapt to the changes of both the first and second metal it must have physical properties that are between the physical properties of the first and second metals. For example, during the constant heating/cooling cycles, the first and second metals 50, 52 heat and cool at different rates and therefore expand and contract at different rates. This differential thermal expansion causes constant flexing and metal fatigue. Therefore, a third metal 56 having a thermal expansion rate that is between the thermal expansion rate of the first and second metals 50, 52 reduces the problem of metal fatigue and resists breaking of the joint.

Since it is expected that the joint will physically function in a similar manner, in the optimum embodiment, the third metal 56 should have bending, stillness and ductility properties between that of the first and second metals 50, 52.

The embodiment of FIG. 4A may be manufactured, for example, using the HIP process described with reference to FIG. 3, where the first and second portions 30, 32 of the joint 16 are made of the first and second metals 50, 52, respectively, and the section 56 of the joint 16 is formed using the powdered metal 40.

In FIG. 4B, the first and second metals 50, 52 are joined by two or more sections 58, 60, and 62, each of which may be formed from different combinations of the first and second metals 50, 52 or from different combinations of the first and second metals 50, 52 with at least one different metal. In one example, the sections 58, 60, and 62 include mixtures of the first and second metals 50, 52 at different ratios. In this example, section 58, which is bonded to the first metal 50, may include a greater proportion of the first metal 50, and section 62, which is bonded to the second metal 52, may include a greater proportion of the second metal 52. More specifically, the section 62 may include 25% by weight first metal 50 and 75% by weight second metal 52; section 60 may include 50% by weight first metal 50 and 50% by weight second metal 52; and section 58 may include 75% by weight first metal 50 and 25% by weight second metal 52.

Alternatively, the sections 58, 60, and 62 may include mixtures of the first and second metals 50, 52 and at least one other metal. For example, the first and second metals 50 and 52 may be an austenitic stainless steel and a ferritic steel, respectively, and a third metal may be a nickel-based alloy such as, for example, Inconel® 625. As with the previous embodiment, section 58, which is bonded to the first metal 50, may include a greater proportion of the first metal 50, and section 62, which is bonded to the second metal 52, may include a greater proportion of the second metal 52. More specifically, the section 62 may include 50% by weight third metal and 50% by weight second metal 52; section 60 may include 100% by weight third metal; and section 58 may include 50% by weight first metal 50 and 50% by weight third metal.

The embodiment of FIG. 4B may be manufactured, for example, using the HIP process described with reference to FIG. 3, where the first and second portions 30 and 32 of the tube joint 16 are made from the first and second metals 50 and 52, respectively, and the sections 58, 60, and 62 of the tube joint 16 are formed using layers of different powdered metals 40.

In FIG. 4C, the tube joint 16 is formed from a mixture of the first and second metals 50 and 52, with the concentration of the first and second metals 50 and 52 changing gradually along the length of the tube joint 16 such that the concentration of the first metal 50 is highest proximate end 20 and the concentration of the second metal 52 is highest proximate end 22. For example, the concentration of the first metal 50 may change from 100% at the end 20 to 0% at the end 22, while the concentration of the second metal 52 may change from 100% at the end 22 to 0% at the end 20. The tube joint 16 in the embodiment of FIG. 4C may be manufactured, for example, using the method described with reference to FIG. 3 without the first and second portions 30 and 32, wherein the first and second metals 50 and 52 are provided as powdered metals 40, and wherein the concentration of the powdered first and second metals 50 and 52 is adjusted to provide the desired change in concentration along the length of the tube joint 16.

Finally, in FIG. 4D, the tube joint 16 comprises two metals, the first and second metals 50 and 52, directly bonded to each other at a common interface 54. The tube joint 16 in the embodiment of FIG. 4D may be manufactured, for example, using the method described with reference to FIG. 3 without the first and second portions 30 and 32, wherein the first and second metals 50 and 52 are provided as powdered metals 40. The bond between the two metals 50 and 52 at interface 54 is strengthened during the HIP process, thus eliminating the need for a DMW at the interface 54.

In each of the embodiments of FIGS. 4A-D, the need form a DMW is eliminated. Surprisingly, testing related to one embodiment of the tube joint 16 revealed that, at least for that embodiment, the tube joint 16 may have a greater life expectancy than that of either the first or second tube sections 12 or 14 (FIG. 1). In other words, not only is the tube joint 16 believed to eliminate the tube failure mode presented by DMWs, it is believed to have a greater life expectancy than the remainder of the tube 10.

Testing was performed using round bar test specimens to represent the embodiment of FIG. 4A wherein the first metal 50 is ASTM A213 grade T-22, a ferritic steel, the second metal is ASTM A213 grade TP347, an austenitic stainless steel, and the section 56 is formed from Inconel® 625, a nickel-based alloy. Inconel® 625 is comprised of 58 weight % Nickel, 20-23 weight % Chromium, 8-10% Molybdenum and 3.15-4.15 weight % Niobium. It was found that Inconel® 625 produced very good results. Each test specimen was manufactured using a HIP process similar to that described with reference to FIG. 3.

A first test specimen was subjected to a cold tensile test using a test range of 3000/6000/12,000 pounds force at a rate of 0.003±0.001 inch/inch/minute. The test specimen was 0.35 inches in diameter, 3.5 inches long, with a gauge length of 1.8 inches. The ultimate tensile strength of the sample was determined to be about 84,000 pounds/square inch (PSI), with a yield strength of about 42,000 PSI. Surprisingly, the failure of the sample occurred at the T22 steel, and not at the interface between the Inconel 625 and either the T22 or the TP347, which indicates a good bond between the different metals in the sample.

A second test specimen was subjected to creep testing at a stress of 8.0 ksi, and a temperature of 1188° F. The test specimen was ⅝ inches in diameter and about 12 inches long, with a gauge length of about 8 inches. Surprisingly, the rupture time for the sample was 2,216 hours, which is about 220% greater than the estimated rupture time for a T22 sample under the same conditions, which is about 1000 hours. While not wanting to be bound by theory, it is believed that the HIP process used to create the test specimen increased the life of the T22 material.

A third test specimen was subjected to creep fatigue testing at a thermal cycle of 149° F. to 1049° F. and a cycle rate of 12 minutes/cycle and 120 cycles/day. The test specimen was ⅝ inches in diameter and about 12 inches long, with a gauge length of about 8 inches. Under such conditions, a typical DMW is expected to fail after about 400 cycles. Surprisingly, the test specimen did not fail after 1000 cycles.

Thus, testing related to one embodiment of the tube joint 16 revealed that, at least for that embodiment, the tube joint 16 provides a greater resistance to creep fatigue than a DMW and indeed is believed to have a greater life expectancy than that of the remainder of the tube 10 (FIG. 1).

The present invention is not to be limited in scope by the specific embodiments described herein. Indeed, various modifications of the present invention in addition to those described herein will be apparent to those of skill in the art from the foregoing description and accompanying drawings. Thus, such modifications are intended to fall within the scope of the appended claims.

What is claimed is:

1. A method of connecting a first heater section of a first metal to a second heater tube section of a second metal having a maximum of 30 weight percent chromium to create an economical heater tube, the method comprising:
providing a first metal having substantially the same chemical composition and properties as the first heater tube section;
providing a second metal having substantially the same chemical composition and properties as a second heater tube section, the chemical composition of the second metal being different than that of the first metal; and
providing a transition section having a powdered third metal having a chemical composition with at least one property between properties of the first and second metals;
applying a hot isostatic press process to the first and second metals to provide a tube joint having a first end formed from the first metal and a second end formed from the second metal;
welding the first heater tube section to the tube joint first end; and
welding the second heater tube section to the tube joint second end.

2. The method of claim 1, wherein the property is thermal expansion rate.

3. The method of claim 1, wherein the first metal is a ferritic steel, and the second metal is an austenitic stainless steel.

4. The method of claim 1, wherein the first metal is a ferritic steel, the second metal is an austenitic stainless steel, and the third metal is a nickel-based alloy.

5. The method of claim 1 wherein the third metal is comprised of approximately 58 weight % Nickel.

6. The method of claim 5 wherein the third metal is further comprised of approximately 20-23 weight % Chromium.

7. The method of claim 6 wherein the third metal is further comprised of approximately 8-10 weight % Molybdenum and 3.15-4.15 weight % Niobium.

8. The method of claim 2, wherein:
the first metal is a ferritic steel that has a chemical composition substantially described by ASTM A213 Grades T11 or T22.

9. The method of claim 1, wherein:
the second metal is an austenitic stainless steel that has a chemical composition selected from the group consisting of:
ASTM A213 Grades TP304, TP304L, TP304H, TP304N, TP304LN, TP309S, TP309H, TP309Cb, TP309HCb, TP310S, TP-310H TP310Cb, TP310HCb, TP310HCbN TP310MoLN, TP347, TP347H, TP347HFG and TP347LN.

10. The method of claim 1, wherein, before applying the hot isostatic press process, the first and second ends of the tube joint are in the form of cylindrical end portions disposed on opposing sides of the powdered third metal.

11. A tube joint adapted to join dissimilar metal sections of a superheater or reheater tube, the tube joint being produced in accordance with the method of claim 1.

12. A method of connecting at least one first superheater or reheater tube section to at least one second superheater or reheater tube section to create a high-quality joint, wherein the first heater tube sections are comprised of different metals from the second heater tube sections, the method comprising:
providing a first cylindrical end portion comprised of a first metal having thermal expansion properties substantially the same as a metal used to form a first section of the heater tube;
providing a second cylindrical end portion comprised of a second metal having second thermal expansion properties substantially the same as a metal used to form a second section of the heater tube, the chemical composition of the second metal being different than that of the first metal;
providing a transition section disposed between the first and second tube joint ends, the transition section being formed from a powdered third metal having thermal expansion properties between those of the first and second metals;
applying a hot isostatic press process to the first and second cylindrical end portions and the transition section to provide a tube joint having a first cylindrical end portion formed from the first metal and a second cylindrical end portion formed from the second metal and a solid transition section bonded to each of the cylinder end portions;
welding the first cylindrical end portion of the tube joint to the first heater tube section; and
welding the second cylindrical end portion of the tube joint to the second heater tube section to connect the first and second heater tube sections.

13. The method of claim 12, wherein the first metal is a ferritic steel, the second metal is an austenitic stainless steel, and the third metal is a nickel-based alloy.

14. The method of claim 12 wherein the third metal is comprised of approximately 58 weight % Ni, 20-23 weight % Chromium.

15. The method of claim 13 wherein the third metal is further comprised of approximately 8-10 weight % Molybdenum and 3.15-4.15 weight % Niobium.

16. The method of claim 13, wherein:
the first metal is a ferritic steel that has a chemical composition substantially described by ASTM A213 Grades T11 or T22.

17. The method of claim 13, wherein:
the second metal is an austenitic stainless steel that has a chemical composition selected from the group consisting of:
ASTM A213 Grades TP304, TP304L, TP304H, TP304N, TP304LN, TP309S, TP309H, TP309Cb, TP309HCb, TP310S, TP-310H TP310Cb, TP310HCb, TP310HCbN TP310MoLN, TP347, TP347H, TP347HFG and TP347LN.

18. A method of forming a tube joint for joining metal sections of a superheater or reheater tube made from metals having dissimilar thermal expansion properties, the method comprising:
providing a first end portion formed from a first metal having substantially the same thermal expansion properties as a metal used to form one of the sections of the superheater or reheater tube;
providing a second end portion formed from a second metal having substantially the same thermal expansion properties as a metal used to form the other of the sections of the superheater or reheater tube, the thermal expansion properties of the second metal being different than that of the first metal;
providing powdered metals between the first and second end portions, the powdered metals being selected from one of:
a mixture of the first, second metals and a third metal,
the third metal having a thermal expansion properties between those of the first and second metals; and
applying a hot isostatic press process to bond the powdered metals with the first and second end portions and provide a tube joint having a first end formed from the first metal and a second end formed from the second metal.

19. The method of claim 18, wherein the first metal is a ferritic steel, the second metal is an austenitic stainless steel, and the third metal is a nickel-based alloy.

20. The method of claim 18 wherein the third metal is comprised of approximately 58 weight % Nickel and 20-23 weight % Chromium.

21. The method of claim 18 wherein the third metal is further comprised of approximately 8-10 weight % Molybdenum and 3.15-4.15 weight % Niobium.

22. The method of claim 18, wherein:
the second metal is an austenitic stainless steel that has a chemical composition selected from the group consisting of:
ASTM A213 Grades TP304, TP304L, TP304H, TP304N, TP304LN, TP309S, TP309H, TP309Cb, TP309HCb, TP310S, TP-310H TP310Cb, TP310HCb, TP310HCbN TP310MoLN, TP347, TP347H, TP347HFG and TP347LN.
